(19) United States
(12) Patent Application Publication
(10) Pub. No.: US 2023/0318651 A1
(43) Pub. Date: Oct. 5, 2023

(54) CASE AND ACCESSORY FOR ELECTRONIC DEVICE

(71) Applicant: Daniel Silva, New Fairfield, CT (US)

(72) Inventor: Daniel Silva, New Fairfield, CT (US)

(21) Appl. No.: 17/710,130

(22) Filed: Mar. 31, 2022

(51) Int. Cl. H04B 1/3888

(52) U.S. Cl. CPC H04B 1/3888

(57) ABSTRACT

A case for an electronic device, such as a smartphone, has a side with an opening, and an accessory fits the opening. The electronic device has magnetic features with magnetic functions, such as magnetic attachment to accessories including magnetic wallets, mounts, and wireless chargers. The opening is dimensioned to provide accessories with direct access to the magnetic features, the magnetic functions, or the electromagnetic field caused by the magnetic features. The opening has a notch or lever that allows a user to lift the accessory off from the magnetic attachment to the electronic device. The notch can extend from the opening or be a separate hole. A button engages the lever via a spring mechanism that brings the lever to its original position when the button is released. The opening has a wall or sidewall that can be straight, slanted, or curved. The edges of the accessory can be straight, slanted, or curved to match the sidewall of the opening to fit into the opening.

### TECHNICAL FIELD

The embodiments generally relate to cases and accessories, and more particularly relate to cases and accessories for phones, smartphones, tablets, and other electronic devices with surface attachment features, such as magnetic features, hook and loop fastners (such as VELCRO®), adhesives, mechanical attachments such as screws and/or hooks and/or snap-fit and/or fittings, and/or the like.

### BACKGROUND

In the last decades, scientific and engineering advancements have enabled the creation of portable and mobile electronic devices. Today, many of these devices are carried by users throughout the day in their pockets, purses, bags, etc. These electronic devices are physically delicate. Even small, low height drops often result in shattered screens, broken parts, and general device malfunction. To avoid damage to an electronic device due to a fall or drop, users cover their phones and electronic devices with cases. Cases generally vary according to the type of device (a case for a phone will be smaller than a case for a large tablet) and the various materials and layers of the cases. For smartphones and tablets, cases will cover the device while not covering the touchscreens, displays, cameras, buttons, and speakers to make available the corresponding ocular, aural, tactile and/or functional access. However, as electronic device technologies have further developed, cases have not evolved to protect the electronic devices while not augmenting, or at least remaining unobstructive, to the new technologies.

One type of technology recently launched in electronic devices is magnetic coupling. Electronic device magnetic feature and/or coupling technologies, such as Qi and MagSafe, provide new features including wireless charging, accessory magnetic attachment, and magnetic device attachment (for example, a smartphone magnetically attaching to a magnetic phone mount, such as a magnetic tripod or a magnetic car phone mount). Placing any material or medium between magnetic articles and the electronic device magnetic feature and/or coupling technology will create distance between the article and the device technology, will change the electromagnetic conditions (for example, a material between the article and the device technology will have new permeability and permittivity) resulting in reduced or loss of functionality, and may even completely block the magnetic connection.

### SUMMARY

This summary is provided to introduce a variety of concepts in a simplified form that is further disclosed in the detailed description of the embodiments. This summary is not intended to identify key or essential inventive concepts of the claimed subject matter, nor is it intended for determining the scope of the claimed subject matter.

The embodiments provided herein relate to an electronic device case including a device magnetic feature facing side having an opening dimensioned at least as expansive as magnetic feature dimensions of an electronic device. The opening is configured to receive a magnetically attachable accessory or a fitting portion of the magnetically attachable accessory. A notch extends from the opening to assist and/or allow users to lift a magnetically attachable accessory off from the electronic device when the magnetically attachable accessory is magnetically attached to the electronic device. The case can include, in leu of or in addition to the notch, a lever configured to lift the magnetically attachable accessory off from the electronic device when the magnetically attachable accessory is magnetically attached to the electronic device.

The opening comprises a straight, slanted, or curved sidewall. The magnetically attachable accessory has sides or edges that match the shape of the opening's sidewall.

In one aspect, the electronic device case has a device magnetic feature facing side having an opening dimensioned to match at least one of dimensions of one or more magnetic features of an electronic device and dimensions of one or more magnetic functions of the one or more magnetic features and a notch extending from the opening.

In one aspect, the electronic device case and the accessory form a set or kit in which the accessory is configured to interact with a magnetic feature of an electronic device, the case has a device magnetic side with an opening dimensioned at least as expansive as dimensions of the magnetic feature of the electronic device. In the kit, the case can also have a notch extending from the opening, and the attachable accessory can have a fitting portion dimensioned to fit in the opening.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1A illustrates an exploded perspective view of the backs of an electronic device, a case for the electronic device, and an accessory magnetically attachable to the electronic device.

FIG. 1B illustrates a perspective view of the electronic device with the case for the electronic device, and the accessory magnetically attached to the electronic device of FIG. 1A.

FIG. 1C illustrates an exploded perspective view of the fronts of the electronic device, the case for the electronic device, and the accessory magnetically attachable to the electronic device of FIG. 1A.

FIG. 1D illustrates a cross-section of the electronic device case of FIGS. 1A-1C with a straight sidewall around an opening.

FIG. 1E illustrates a cross-section of the electronic device case of FIGS. 1A-1C with a slanted sidewall around an opening.

FIG. 1F illustrates a cross-section of the electronic device case of FIGS. 1A-1C with a curved sidewall around an opening.

FIG. 1G illustrates a cross-section of the electronic device case of FIGS. 1A-1C with a flange around an opening.

FIG. 1H illustrates a cross-section of the electronic device case of FIGS. 1A-1C with an overhang around an opening.

FIG. 1I illustrates a cross-section of the electronic device case of FIGS. 1A-1C with a depression formed by walls and a layer.

FIG. 2A illustrates an exploded perspective view of the backs of an electronic device, a case for the electronic device, and an accessory magnetically attachable to the electronic device.

FIG. 2B illustrates a perspective view of the front of the accessory of FIG. 2A.

FIG. 3A illustrates an exploded perspective view of the backs of an electronic device, a case for the electronic device, and an accessory magnetically attachable to the electronic device.

FIG. 3B illustrates a perspective view of the front of the accessory of FIG. 3A.

### DETAILED DESCRIPTION

Any specific details of embodiments are used for demonstration purposes only, and no unnecessary limitations or inferences are to be understood therefrom.

Before describing in detail exemplary embodiments, it is noted that the embodiments reside primarily in combinations of components and procedures related to the apparatus. Accordingly, the apparatus components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship, or order between such entities or elements. Similarly, as used herein, technical terms related to electromagnetism, such as “magnetic,” “magnetic field,” “magnetic wave,” and the like, are meant to be interpreted broadly and to include characteristics of functional or distinct variations, such as “magnetic” including electric and/or electromagnetic and/or the like, and “wave” and/or “field” including oscillation, signal, communication, transmission, transfer, induction, and/or the like.

The embodiments generally relate to cases and accessories, and more particularly relate to cases and accessories for phones, smartphones, tablets, and other electronic devices with magnetic features.

In general, the embodiments provided herein relate to cases and accessories for phones, smartphones, tablets, and other electronic devices with magnetic features. A case and an accessory include the case having an opening through which the accessory, or part of the accessory, fits. The opening is dimensioned such that a magnetic feature of the electronic device is accessible through the opening when the electronic device is inside the case. The accessory, or a part or portion of the accessory, is dimensioned to fit the opening and configured to interact with the magnetic feature.

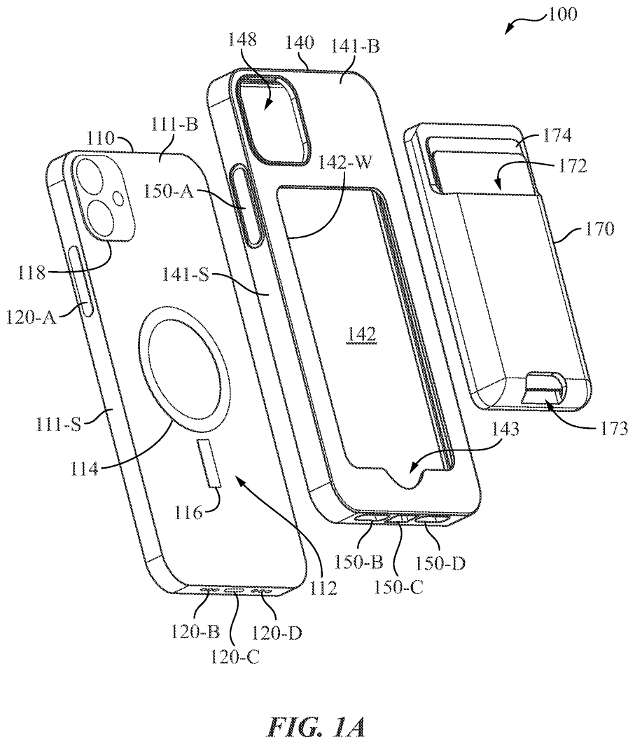

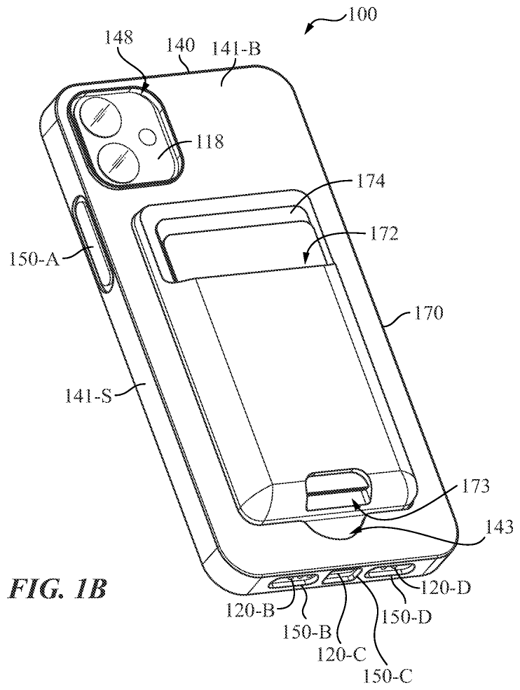

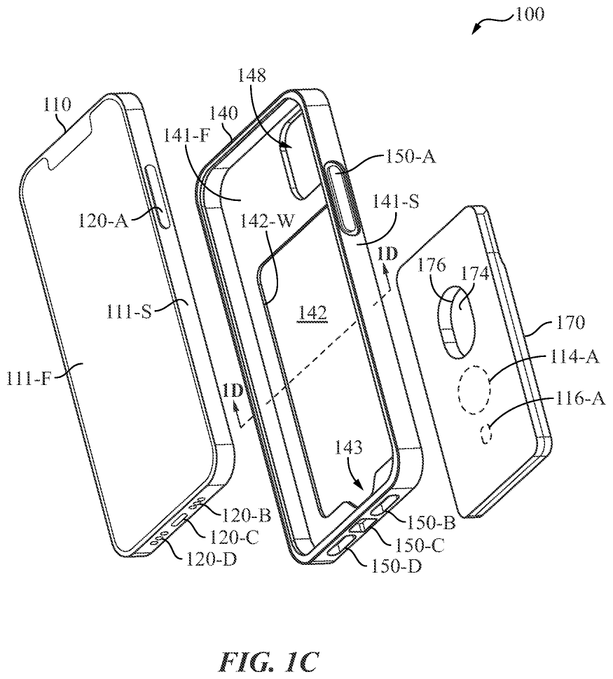

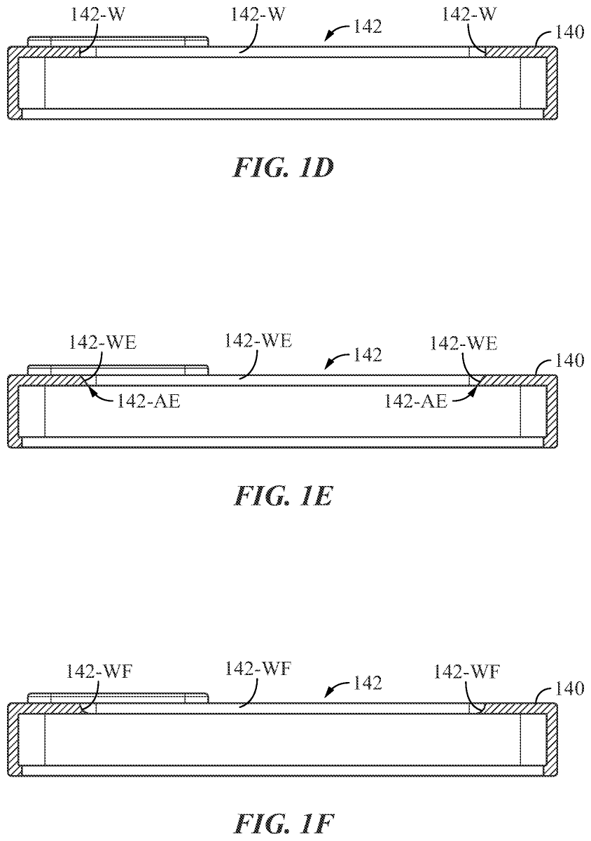

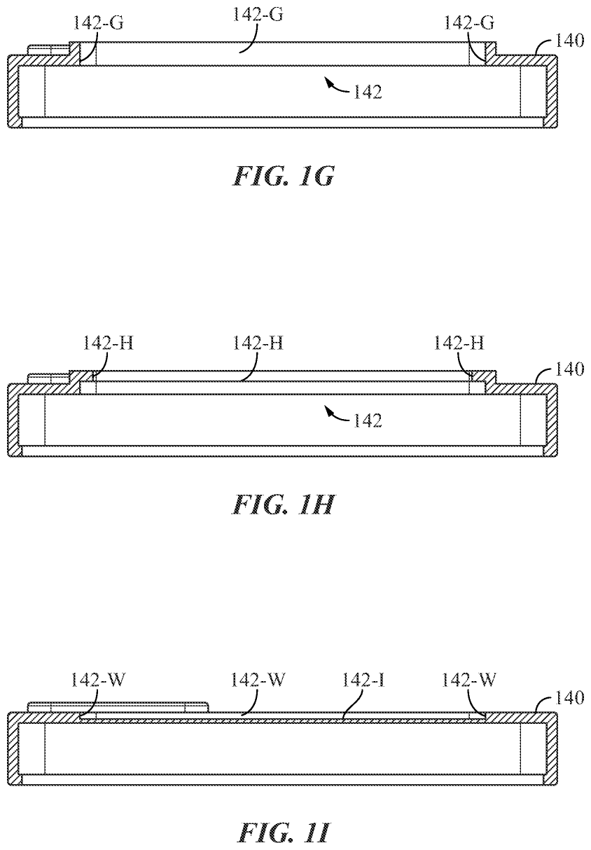

FIGS. 1A, 1B, and 1C illustrate an electronic device protector kit 100 for an electronic device 110. The electronic device protector kit 100 includes an electronic device case 140 and a magnetically attachable accessory 170. The figures show the electronic device 110 is a smartphone, but the electronic device 110 may be any type of electronic device including smartphones, mobile phones, tablets, laptops, portable screen displays, touchscreen displays or devices, magnetic electronic devices, and the like.

The electronic device 110 has a back 111-B and sides 111-S. The electronic device 110 has various input/output features, including a button 120-A on one of the lateral sides 111-S and a microphone 120-B, a plug connector 120-C, and a speaker 120-D at the bottom of the electronic device 110. The case 140 has input/output feature enablers, including a soft button 150-A configured to engage the button 120-A when the soft button 150-A is pressed, and apertures 150-B, 150-C, and 150-D, each aperture dimensioned to provide access to the microphone 120-B, the plug connector 120-C, and the speaker 120-D, respectively. It will be apparent to persons of ordinary skill in the art that various types of electronic devices will have different numbers and types of input/output features at various locations throughout the device, including phone jacks, ethernet ports, media ports, audio jacks, power buttons, volume buttons, multiple speakers, multiple microphones, various cameras, and/or the like. In some embodiments, the plug connector 120-C is a type of USB plug, such as USB-C, or a proprietary type of connector. The plug connector 120-C can be used for charging, discharging, sending data, receiving data, sync operations, or media input/output to other devices (such as wired headphones, speakers, keyboards, haptic devices, displays), and/or the like. There can be cases, such as the electronic device case 140, that contemplate all such variations and combinations, including having openings and/or access features and/or feature enablers with the appropriate positions, dimensions, and configurations for operation of the corresponding electronic device.

The electronic device 110 also has one or more magnetic features 112. FIG. 1A shows the magnetic features 112 include a ring magnetic feature 114 and an orientation magnetic feature 116. The magnetic features 112, or portions or parts of the magnetic features 112, can generate, activate, operate, include, and/or cause one or more magnetic functions, including capabilities to charge the electronic device 110, discharge the electronic device 110, accessory magnetic attachment, magnetically attach to mounts, magnetically orientate and/or keep in place and/or maintain the orientation of an attachment to the magnetic feature 112, transmit data, receive data. For example, a charger that needs to attach in a particular orientation to operate could engage and/or interact for orientation with the orientation magnetic feature 116 and charge the electronic device 110 through engage and/or interact with the ring magnetic features 114. It will be apparent to persons of ordinary skill in the art that different electronic devices may have different implementations of magnetic features and/or magnetic functions. The one or more magnetic features 112 may have different shapes, positions, sizes, dimensions, functions, electric or magnetic or electromagnetic waves or fields (including variations in wave and/or field strength, density, direction, waveform, wavefront, shape, wavelength, frequency, phase, speed, velocity, direction, amplitude, magnitude, mode, bias, etc.). The one or more magnetic features 112 may cooperate and/or operate independently. For example, a ring magnetic feature 114 might implement orientation functions, or rely on the orientation magnetic feature 116 for attachments or accessories that need to be adjusted to a particular orientation for proper operation, such as a charging pad configured to charge the electronic device 110 through the magnetic features 112. As another example, the one or more magnetic features might have square, triangular, rectangular, or any other geometric shape, and have different sizes, positions, and/or portions with different magnetic functions, including one or more magnetic features enclosed by another magnetic feature.

Magnetic features, such as the magnetic features 112, create one or more magnetic fields which may include other waves, fields, and/or signals transmitted through electromagnetic waves, and may also include or implement different functions or protocols for communication. Similarly, magnetic features, such as the magnetic features 112, may receive or interact with one or more magnetic fields from other devices which may include other waves, fields, and/or signals transmitted through electromagnetic waves, and may also include or implement different functions or protocols for communication. Generally, cases that cover magnetic features are likely to dampen or completely block the magnetic features and magnetic functions due to the permittivity and permeability of the material and/or layers of the case covering the magnetic features. The permittivity and permeability of a material describes the electromagnetic properties of a material or medium, and may be frequency-dependent, change across the material, and vary according to the strength and direction of the electromagnetic wave in the material or medium, and may also vary according to temperature, humidity, and other factors.

FIGS. 1A and 1C show the case 140 has a back 141-B, a front 141-F, and an opening 142. The case's front 141-F (which is the device attachment feature facing side or the device magnetic feature facing side of the case 140, or device magnetic side) faces towards the electronic device's back 111-B when the electronic device 110 is inserted into the case 140. The case 140 is made of a material that is flexible to accept the insertion and the removal of the electronic device 110 with manual force from a user, rigid to maintain the electronic device 110 secure inside the case 140 (not letting the electronic device 110 slip out of the case 140 due to minimal force or a drop), and strong and/or elastic to protect the electronic device from and/or to cushion hits, blows, drops, scuffs, and/or the like. In some embodiments, the materials that the case 140 (or one or more layers or parts of the case 140) is made of include one or more of the following: plastic, rubber, natural rubber, polycarbonate, polyurethane, thermoplastic polyurethane (TPU), silicone, latex, elastomer, polymer, acrylic, Neoprene®, polyethylene, polypropylene, polyvinyl chloride (PVC), fiberglass, non-toxic materials, fluorescent materials (assists in finding the case 140 and the electronic device 110 in low-light conditions), leather, foam, wood, metal, rocks, glass, crystals, ore, magnets, minerals, and/or the like, whether naturally occurring or synthetic (for example, leather and synthetic leather, wood and plywood and bamboo and hemp and cork and MDF— medium density fiberboard), including any species, versions, variations, modifications, and combinations of the materials (for example, placing additives in one of the materials to change the properties and characteristics of the material).

The opening 142 is dimensioned at least as expansive as the dimensions of the magnetic features 112. In some embodiments, the opening 142 is dimensioned at least as expansive as to permit the operation of the magnetic functions. In some embodiments, the case 140 has multiple openings 142 permitting part of or the whole operation of the magnetic functions. In some embodiments, the opening 142 or openings 142 are dimensioned to have the shape of the one or more magnetic features. The case 140 is configured to have the opening 142 positioned to expose the magnetic features 112 when the case 140 is mounted on the electronic device 110. In some embodiments, the case 140 is configured to have the opening 142 positioned to expose only part of the magnetic features 112, or at least part of the magnetic features 112, when the case 140 is mounted on the electronic device 110.

FIG. 1B illustrates the accessory 170 in the opening 142 and attached to the electronic device 111 that cannot be seen (but for the camera 148 and through the notch 143) inside the case 140. FIGS. 1A, 1B, and 1C show the accessory 170 is a wallet. In some embodiments, the accessory 170, is or is part of a mount, a car mount, a tripod, an extended battery, a charger, a supplemental cover (for when no other accessory is used), a box or enclosure, a pouch, a fan, a grip or handle, a hand strap, a wrist strap, an electronic and/or wireless locator, visual and/or electronic tag (for example, a visual identification or ID holder, a QR code presenter and/or reader and/or touchscreen and/or display, an RFID, and/or the like), a camera, a controller or interface, a speaker, a cover with an extendable flap member configured to hold the electronic device at an angle on a surface, a stand (to hold the electronic device 110 in), a different electronic device, and/or the like (all, not shown), including any combination of such accessories. In some embodiments, the case 140 includes an extendable flap member configured to elevate the electronic device at an angle on a surface (not shown). The accessory 170, as a wallet, has inserts 174 inside a wallet enclosure 172. The wallet enclosure 172 is configured to receive the inserts 174. The inserts 174 are cards (for example, business cards, credit cards, debit cards, identifications, and/or the like), papers, money, and/or anything else that can fit inside the wallet enclosure 172. The accessory 170 has an aperture 173. The aperture 173 is configured to a size, shape, and/or dimensions that allow the user to push one or more of the inserts 174 with a finger and/or with a stick. Thus, the aperture 173 is configured to allow a user to push out inserts 174 that are stuck inside the wallet enclosure 172 and/or that are small or have otherwise slipped inside the wallet enclosure 172 such that those inserts 174 can no longer be pulled out through the opening of the wallet enclosure 172.

FIG. 1C illustrates the side of the accessory 170 that faces and interacts with the electronic device 110 via an accessory magnetic feature 114-A and an accessory orientation feature 116-A. The accessory magnetic feature 114-A and/or the accessory orientation feature 116-A are configured to match and/or interact with one or more of the magnetic features 112 and/or one or more of the magnetic functions. The accessory magnetic feature 114-A and the accessory orientation feature 116-A are physically inside the accessory 170. In some embodiments, the accessory magnetic feature 114-A and/or the accessory orientation feature 116-A form part of the surface of and/or are at the surface of and/or protrude from the surface of the accessory 170. An insert opening 176 is also shown in FIG. 1C. Similar to the aperture 173, the insert opening 176 is configured to a size, shape, and/or dimensions that allow the user to slide one or more of the inserts 174 with a finger and/or with a stick. In some embodiments, the aperture 173 and the insert opening 176 are configured and/or located to complement each other with respect to accessing and removing inserts 174 that are stuck or are otherwise difficult or impossible to remove from the wallet enclosure 172.

The accessory 170 is configured to fit into the opening 142. In some embodiments, the accessory 170 is configured to such that one or more portions of the accessory 170 fit into one or more openings 142 (or into a plurality of openings 142). In some embodiments, the accessory 170 is configured to fit into one or more openings 142 (or to fit into a plurality of openings 142). In some embodiments, the opening 142 is configured to accept or fit an accessory 170. For the accessory 170 (or one or more portions of the accessory 170) to be configured to fit into the opening 142, the accessory 170 (or one or more portions of the accessory 170) is dimensioned, sized, and/or shaped to match and fit the opening 142 (or the one or more openings 142). In some embodiments, the accessory 170 (or one or more portions of the accessory 170) is not as large as the opening 142 or does not occupy all of the area of the opening 142.

FIG. 1C illustrates a different angle of the exploded perspective view of FIG. 1A. In this view, FIG. 1C shows an electronic device front side 111-F,

One or more walls or sidewalls 142-W define the dimensions of the opening 142. The walls 142-W are perpendicular to the back 141-B and to the front 141-F. In some embodiments, the walls 142-W have an angle and/or a curve. Alternative embodiments are shown in FIGS. 1E and 1F, which illustrate alternative cross-sections of the case 140.

FIG. 1E illustrates the opening 142 defined by one or more slanted walls or sidewalls 142-WE. The orientation of the slope of the one or more slanted sidewalls 142-WE creates an angle 142-AE between the case front 141-F and the one or more slanted sidewall 142-WE.

FIG. 1F illustrates the opening 142 defined by one or more concavely curved walls or sidewalls 142-WF. In some embodiments, the opening 142 is defined by one or more convexly curved walls or sidewalls. In various embodiments, the curve of the one or more curved sidewalls 142-WF is an arc (part of a circle or of a circumference), elliptical, parabolic, hyperbolic, an irregular curve, and/or the like.

In some embodiments, the edges and/or sides of the accessory 170 that correspond to the one or more sidewalls 142-W/142-WE/142-WF, with such edges being configured to match the shape of the one or more sidewalls 142-W/142-WE/142-WF (i.e., the edges of the magnetically attachable accessory 170 are straight, slanted, or curved according to the type of wall/sidewall of the opening 142).

In some embodiments, the use of either a slanted wall, such as the one or more slanted sidewalls 142-WE, or a curved wall, such as the one or more curved sidewalls 142-WF, allows for a wider margin of error in the manufacturing of the electronic device case 140 and/or the magnetically attachable accessory 170 with respect to the magnetically attachable accessory 170 (or a portion of the magnetically attachable accessory 170) fitting into the opening 142. The use of either a slanted wall, such as the one or more slanted sidewalls 142-WE, or a curved wall, such as the one or more curved sidewalls 142-WF, makes it simpler for a user to place an accessory, such as the magnetically attachable accessory 170 (or a portion of the magnetically attachable accessory 170), into the opening 142 for attachment, engagement, and/or operation with the magnetic features 112 and/or the magnetic functions. The smaller the angle 142-AE for the one or more slanted sidewalls 142-WE, or the more open and/or the more slanted and/or the less concave the one or more curved sidewalls 142-WF, the easier it can become for the magnetically attachable accessory 170 to slide or be pushed off from the magnetic connection with the electronic device 110. The chances for the magnetically attachable accessory 170 to slide or be pushed off from the magnetic connection will also depend on (1) the force of the magnetic attachment between the electronic device 110 and the magnetically attachable accessory 170, (2) the materials of the surfaces of the electronic device 110, the electronic device case 140 (including the one or more sidewalls 142-W/142-WE/142-WF) and the frictions of the surfaces among them, and/or (3) the tightness of the fit of the magnetically attachable accessory 170 in the opening 142. Note that the one or more sidewalls 142-W/142-WE/142-WF can have any number of orientations, shapes (each sidewall could be a line, curve, or a line/curve combination, forming squares, circles, triangles, stars, rectangles, ellipses, semicircles, trapezoids, pentagons, hexagons, octagons, irregular shapes, and/or the like), lengths, sizes, and configurations.

The thickness of the electronic device case 140 corresponds to the height of the one or more sidewalls 142-W/142-WE/142-WF. The configuration of the electronic device case 140, and in particular of the opening 142, results in the thickness not being an issue that would cause a lessened functionality or block the functionality of the magnetic features 112. Otherwise, the magnetic features 112 and any accessories or components, such as the magnetically attachable accessory 170, would have an intervening material between them. Even if such an intervening material had no significant effect in the magnetic fields or waves from the magnetic features 112, the intervening material would still create a distance and separation between the magnetic features 112 and any accessories or components, such as the magnetically attachable accessory 170. To reduce the distance and separation, the case thickness could be lowered, but lowering the thickness has an effect of the protective characteristics of a case. It is preferable to maintain the case thickness while enabling the magnetic features 112 as shown by the electronic device case 140.

In some embodiments, as shown in FIGS. 1A, 1B, and 1C, the case 140 includes a notch 143 that extends or protrudes from the opening 142. The notch 143 is dimensioned such that a user can flip out an attached accessory with a finger. The notch 143 is located towards the bottom of the opening 142. In some embodiments, the notch 143 is located towards the top, towards one of the sides, or at one of the angles/corners (not shown) of the opening 142. In some embodiments, the notch 143 is a separate opening of the case 140 and does not protrude from the opening 142. In some embodiments, the notch 143 is a depression (not shown) on the surface of the back side 141-B. In some embodiments, the case 140 includes one or more notches 143, which may be openings and/or depressions that are protruding and/or separate from the opening 142.

In some embodiments, as another alternative for removal of an accessory (such as the accessory 170) that is attached to the electronic device 110, the case 140 has a lever (not shown) actuated by a lever button (not shown). The lever button can be located close to the opening 142. The lever can be a thin tab or plank located close to the wall 142-W/142-WE/142-WF. The lever tab, when raised, lifts the accessory 170 out of the opening 142. The pressing of the lever button causes a lever mechanism to raise the lever. Because the tab needs to be rigid enough to lift the accessory 170, in some embodiments, the lever is made of one or more materials that are rigid, or is made of one or more layers of rigid material (such as metal, wood, and/or high rigidity plastics, rubbers, and/or the like) enclosed by rubber, plastic, or any of the materials from which the case 140 is made or could be made (see the materials that could be used to make the case 140, above). In some embodiments, the accessory 170 has a hole or depression (not shown) configured to be located to match the dimension of the hole and dimensioned so that the lever fits the hole when not lifted, but that when the lever is lifted, the lever pushes the surface of the hole, and consequently the accessory 170, out of the opening 142. The lever mechanism (not shown) raises the lever by raising the whole lever, by raising a part or an edge of the lever, by generating torque at an edge or a part of the lever, and/or the like. When the lever button is released, a spring mechanism (not shown) of the lever mechanism moves the lever back to the original position (not raised) of the lever.

FIG. 1G illustrates a cross-section of the electronic device case 140 with a flange 142-G around the opening 142. The flange 142-G adds support and/or stability to an accessory, such as magnetic accessory 170, when attached to the electronic device 110. The top of the flange 142-G can be continuous and/or level with the surface of the electronic device case back 141-B (not shown). In FIG. 1G, the top of the flange 142-G protrudes from the surface of the electronic device case back 141-B. The flange 142-G is made of the same material as the electronic device case 110 and/or another material. In some embodiments, the flange 142-G has one or more layers and/or one or more portions made of a highly rigid material (such as metals or ceramic),

FIG. 1H illustrates a cross-section of the electronic device case 140 with an overhang 142-H around the opening 142. In some embodiments, the flange 142-G includes or is part of or supports the overhang 142-H. The overhang 142-H surrouns the opening 142 except for an accessory insertion portion for the overhang 142-H, which does not have the overhang 142-H and is dimensioned for inserting the accessory 170 (or part of the accessory 170). For example, if the accessory insertion portion for the overhang 142-H is at the bottom (towards the apertures 150-B, 150-C, and 150-D), a user can slide the accessory 170 (or part of the accessory 170) through the overhangs 170, such that the accessory has access and/or contact with any surface attachment features and/or magnetic features 112 and/or magnetic functions of the electronic device 110. In some embodiments, the electronic device case 140 has one or more accessory insertion portions for the overhang 142-H. The overhang 142-H adds stability and makes it hard (or practically impossible) for the accessory 170 to be disconnected, pulled, removed, and/or slid off from the attachment or magnetic connection with the electronic device 110, except through the accessory insertion portion for the overhang 142-H.

FIG. 1I illustrates a cross-section of the electronic device case 140 but with the opening 142 replaced by a depression formed by the sidewalls 142-W and a layer 142-I. The layer 142-I covers the area dimensioned by the one or more sidewalls 142-W. The layer 142-I incorporates the characteristics and features of the opening 142. The shape, position, size, and/or dimensions fo the layer 142-I are defined bu the one or more sidewalls 142-W. The layer 142-I has a side towards the electronic device case front 141-F and a side towards the electronic device case back 141-B. The side of the layer 142-I towards the electronic device case front 141-F shares the surface in a continuous manner with the rest of the electronic device case front 141-F. In some embodiments, the distance between the electronic device case front 141-F and the side of the layer 142-I facing towards the electronic device case front 141-F is shorter than the distance between the electronic device case back 141-B and the side of the layer 142-I facing towards the electronic device case back 141-B. In some embodiments, the layer 142-I is made of the same material as the rest of the electronic device case 140 and/or additional materials (metal, ceramic, other rubbers and/or plastics, and/or the like). The layer 142-I is configured to allow, enable, and/or not impede the operation of the mangnetic features 112 and/or magnetic functions, the propagation of magnetic fields and/or waves through the layer 142-I, the and/or the interaction, communication, attachment, engagement and/or operation between the magnetic accessory 170, the magnetic features 112, and/or the magnetic functions. The thickness and/or the materials of the layer 142-I allow the propagation of magnetic fields and/or waves through the layer 142-I. In some embodiments, the layer 142-I includes one or more holes and/or supplemental magnetic features (such as magnets, conduits, and/or materials) that minimize any negative effect of the layer 142-I on the the magnetic accessory 170, the magnetic features 112, and/or the magnetic functions,

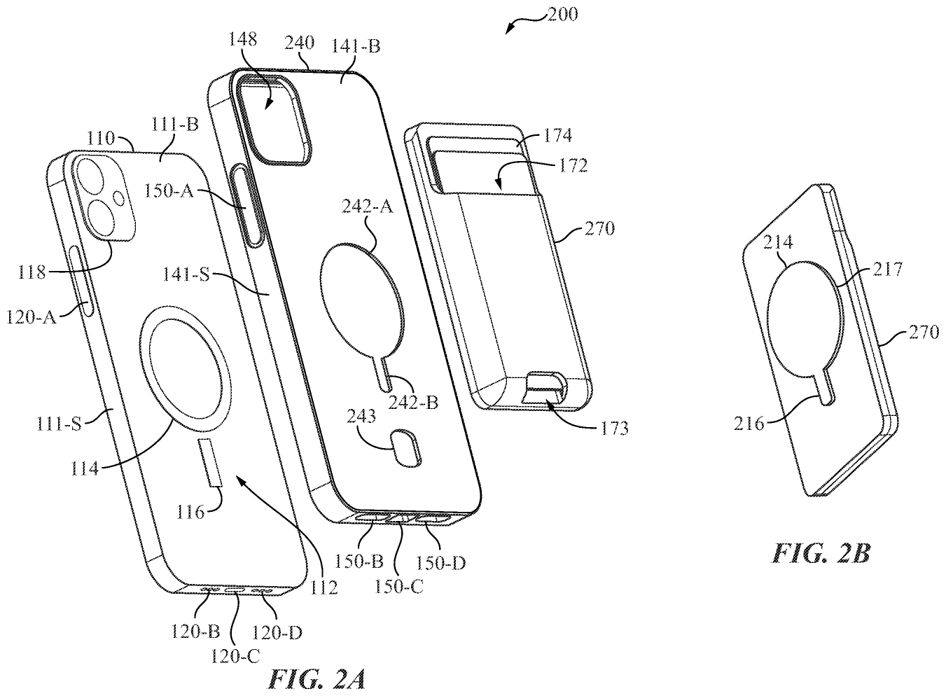

FIG. 2A illustrates a electronic device protector kit 200 for an electronic device 110. The electronic device protector kit 200, which incorporates the characteristics and features of the electronic device protector kit 100, includes an electronic device case 240 and a magnetically attachable accessory 270. The case 240, which incorporates the characteristics and features of the case 140, has an opening 242-A and separately a notch 243. The opening 242-A, which incorporates the characteristics and features of the opening 142, is dimensioned to the shape, size, location, dimensions, and/or configuration of the ring magnetic feature 114. In FIG. 2A, the opening 242-A takes the form of a circle that matches the ring magnetic feature 114 and/or the corresponding magnetic functions. The opening 242-A has an opening extension 242-B that incorporates the characteristics and features of the opening 142. The opening extension 242-B is dimensioned to the shape, size, location, dimensions, and/or configuration of the orientation magnetic feature 116. In FIG. 2A, the opening extension 242-B takes the form of a line or bar opening that matches the orientation magnetic feature 116 and/or the corresponding magnetic functions. The notch 243, which incorporates the characteristics and features of the notch 143, does not extend from the opening 242-A and/or the opening extension 242-B. In some embodiments, the notch 243 extends from the opening 242-A and/or the opening extension 242-B.

FIG. 2B illustrates the opposite side of the accessory 270, which incorporates the characteristics and features of the accessory 170 and which has an accessory magnetic feature 214 and an accessory orientation feature 216. The accessory magnetic feature 214, which incorporates the characteristics and features of the accessory magnetic feature 114-A, is configured to fit the opening 242-A. The accessory orientation feature 216, which incorporates the characteristics and features of the accessory orientation feature 116-A, is configured to fit the opening extension 242-B.

The accessory magnetic feature 214 and/or the accessory orientation feature 216 are configured to match and/or interact with one or more of the magnetic features 112 and/or one or more of the magnetic functions. The accessory magnetic feature 214 and the accessory orientation feature 216 protrude from the surface of the accessory 270. The accessory magnetic feature 214 and the accessory orientation feature 216 have an accessory protrusion wall 217. The height of the accessory protrusion wall 217 (meaning the length that the protrusion extends away from the surface of the accessory 270) is the same as the thickness of the case 240. In some embodiments, the height of the accessory protrusion wall 217 is the same or less than the thickness of the case 240. In some embodiments, the accessory 270 has the accessory magnetic feature 214 without the accessory orientation feature 216. In some embodiments, the accessory 270 has the accessory orientation feature 216 without the accessory magnetic feature 214.

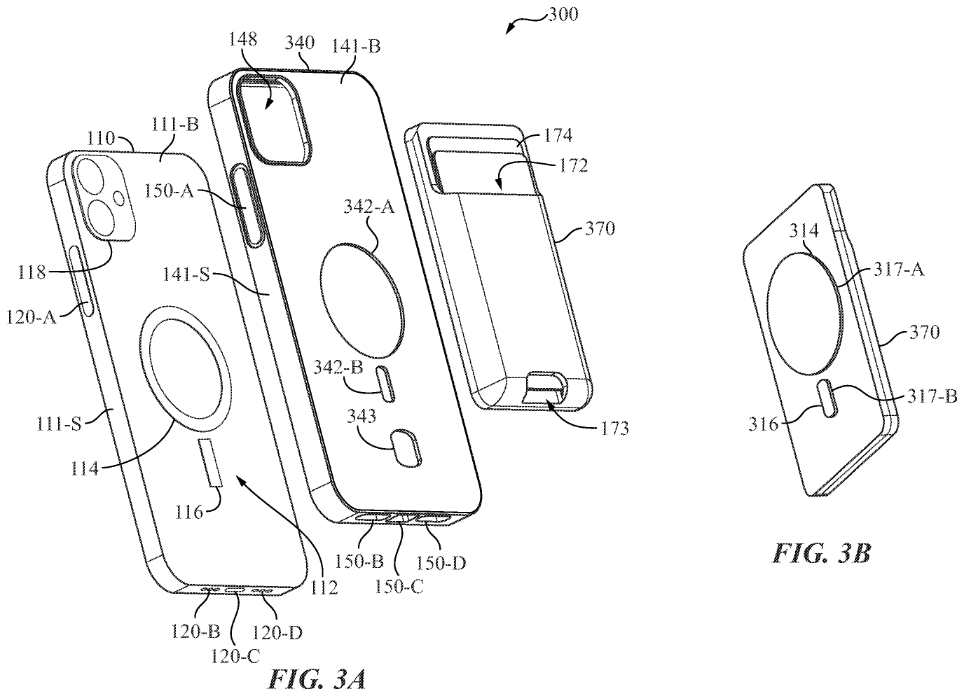

FIG. 3A illustrates an electronic device protector kit 300 for an electronic device 110. The electronic device protector kit 300, which incorporates the characteristics and features of the electronic device protector kit 200, includes an electronic device case 340 and a magnetically attachable accessory 370. The case 340, which incorporates the characteristics and features of the case 240, has an opening 342-A and separately a notch 343. The opening 342-A, which incorporates the characteristics and features of the opening 242-A, is dimensioned to the shape, size, location, dimensions, and/or configuration of the ring magnetic feature 114. In FIG. 3A, the opening 242-A takes the form of a circle that matches the ring magnetic feature 114 and/or the corresponding magnetic functions. The case 340 has an orientation opening 342-B that incorporates the characteristics and features of the opening extension 242-B and that is separate from the opening 342-A. The orientation opening 342-B is dimensioned to the shape, size, location, dimensions, and/or configuration of the orientation magnetic feature 116. In FIG. 3A, the orientation opening 342-B takes the form of a line or bar opening that matches the orientation magnetic feature 116 and/or the corresponding magnetic functions. The notch 343, which incorporates the characteristics and features of the notch 243, does not extend from the opening 342-A and/or the orientation opening 342-B. In some embodiments, the notch 343 extends from the opening 342-A and/or the orientation opening 342-B.

FIG. 3B illustrates the opposite side of the accessory 370, which incorporates the characteristics and features of the accessory 270 and which has an accessory magnetic feature 314 and an accessory orientation feature 316. The accessory magnetic feature 314, which incorporates the characteristics and features of the accessory magnetic feature 214, is configured to fit the opening 342-A. The accessory orientation feature 316, which incorporates the characteristics and features of the accessory orientation feature 216, is configured to fit the opening extension 342-B.

The accessory magnetic feature 314 and/or the accessory orientation feature 316 are configured to match and/or interact with one or more of the magnetic features 112 and/or one or more of the magnetic functions. The accessory magnetic feature 314 and the accessory orientation feature 316 protrude from the surface of the accessory 370. The accessory magnetic feature 314 has a first accessory protrusion wall 317-A. The accessory orientation feature 316 has a second accessory protrusion wall 317-B. The height of the first and second accessory protrusion walls 317-A and 317-B (meaning the length that the protrusions extend away from the surface of the accessory 370) is the same as the thickness of the case 340. In some embodiments, the height of the accessory protrusion wall 217 is the same or less than the thickness of the case 240. In some embodiments, the accessory 370 has the accessory magnetic feature 314 without the accessory orientation feature 316. In some embodiments, the accessory 370 has the accessory orientation feature 316 without the accessory magnetic feature 314.

It will be apparent to persons having ordinary skill in the art that any and all descriptions and/or elements relating to magnetic attachment can also be used for or be contemplated as surface attachment features, such as hook and loop fastners (such as VELCRO®), adhesives, mechanical attachments such as screws and/or hooks and/or snap-fit and/or fittings, and/or the like. Therefore, an electronic device 110 may have one or more of surface attachment features, including hook and loop fastners (such as VELCRO®), adhesives, mechanical attachments such as screws and/or hooks and/or snap-fit and/or fittings, magnetic features (including magnetic attachment features and/or the magnetic features 112), and/or the like. An electronic device case, such as electronic device case 140/240/340, includes and contemplates having variations of openings positioned, sized, shaped, configured, and/or otherwise dimensioned to expose, allow access to, fit over and/or around, and/or expand at least to the dimensions of one or more surface attachment features. For example, an electronic device may have a ring magnetic feature with a concentrical hook and/or loop fastener feature around and surrounding the ring magnetic feature, over the ring magnetic feature, and/or inside and surrounded by the ring magnetic feature. In some embodiments, an electronic device case (such as electronic device case 140/240/340, has one or more openings (such as the opening 142/242-A, 242-B/342-A, 342-B) that positioned, sized, shaped, configured, and/or otherwise dimensioned to expose, allow access to, fit over and/or around, and/or expand at least to the dimensions of one or more magnetic features (such as the magnetic features 112) and/or one or more surface attachment features.

Many different embodiments have been disclosed herein, in connection with the above description and the drawings. It will be understood that it would be unduly repetitious and obfuscating to describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that what has been particularly shown and described hereinabove is not limiting and is not to be interpreted as foreclosing modifications and variations. A variety of modifications and variations are possible in light of the above teachings without departing from the following claims.

What is claimed is:

1. An electronic device case, comprising:
a device attachment feature facing side having an opening dimensioned at least as expansive as at least one of surface attachment feature dimensions of or as magnetic feature dimensions of an electronic device, wherein the electronic device has at least one of a surface attachment feature and a magnetic feature.

2. The electronic device case of claim 1, further comprising:
a lever configured to lift a magnetically attachable accessory off from the electronic device when the magnetically attachable accessory is magnetically attached to the electronic device.

3. The electronic device case of claim 1,
wherein the opening is further dimensioned to receive a magnetically attachable accessory.

4. The electronic device case of claim 1,
wherein the opening is further dimensioned to receive a fitting portion of a magnetically attachable accessory.

5. The electronic device case of claim 1, further comprising:
a notch extending from the opening.

6. The electronic device case of claim 5,
wherein the opening is further dimensioned to receive a magnetically attachable accessory, and the notch is configured to allow a user to lift the magnetically attachable accessory off from the electronic device when the magnetically attachable accessory is magnetically attached to the electronic device.

7. The electronic device case of claim 5,
wherein the opening is further dimensioned to receive a fitting portion of a magnetically attachable accessory, and the notch is configured to allow a user to lift the magnetically attachable accessory off from the electronic device when the magnetically attachable accessory is magnetically attached to the electronic device.

8. The electronic device case of claim 6, wherein the opening comprises a curved sidewall.

9. The electronic device case of claim 6, wherein the opening comprises a slanted sidewall.

10. The electronic device case of claim 7, wherein the opening comprises a curved sidewall.

11. The electronic device case of claim 7, wherein the opening comprises a slanted sidewall.

12. An electronic device case comprising:
a device magnetic feature facing side having an opening dimensioned to match at least one of:
dimensions of one or more magnetic features of an electronic device,
dimensions of one or more magnetic functions of the one or more magnetic features of the electronic device, and
a notch extending from the opening.

13. The electronic device case of claim 12,
wherein the opening is further dimensioned to receive a magnetically attachable accessory, and the notch is configured to allow a user to lift the magnetically attachable accessory off from the electronic device when the magnetically attachable accessory is magnetically attached to the electronic device.

14. The electronic device case of claim 12,
wherein the opening is further dimensioned to receive a fitting portion of a magnetically attachable accessory, and the notch is configured to allow a user to lift and remove the magnetically attachable accessory from the electronic device when the magnetically attachable accessory is magnetically attached to the electronic device.

15. The electronic device case of claim 13, wherein the opening comprises a curved sidewall.

16. The electronic device case of claim 13, wherein the opening comprises a slanted sidewall.

17. The electronic device case of claim 14, wherein the opening comprises a curved sidewall.

18. The electronic device case of claim 14, wherein the opening comprises a slanted sidewall.

19. An electronic device case and magnetically attachable accessory kit, comprising:
an accessory configured to interact with a magnetic feature of an electronic device; and
a case comprising a device magnetic feature facing side, the device magnetic feature facing side having a depression or an opening dimensioned at least as expansive as dimensions of the magnetic feature of the electronic device,
wherein the depression is formed by one or more sidewalls and a layer.

20. The electronic device case and magnetically attachable accessory kit of claim 19,
wherein the electronic device case further comprises a notch extending from the opening, and
wherein the magnetically attachable accessory comprises a fitting portion dimensioned to fit in the opening.
